(19) United States
(12) Patent Application Publication
(10) Pub. No.: US 2003/0230540 A1
(43) Pub. Date: Dec. 18, 2003

(54) Engine coolant filter apparatus and method

(76) Inventor: Phillip D. Mooneyham, Dell Valley, TX (US)

Correspondence Address: Rick B. Yeager, 10805 Mellow Lane, Austin, TX, 78759, US

(21) Appl. No.: 10/601,377

(22) Filed: Jun. 23, 2003

Related U.S. Application Data
(63) Continuation-in-part of application No. 09/931,230, filed on Aug. 16, 2001, now Pat. No. 6,582,613.

(51) Int. Cl. C02F 1/00; B01D 35/18

(52) U.S. Cl. 210/774

(57) ABSTRACT

A method and apparatus for filtering particulate matter from internal combustion engine coolant where a replaceable filter is connected between the heater core supply and return lines. A housing that clamps directly to the heater supply and return hoses so that a first portion of the flow is directed through a filter media, and a second portion of the fluid flow bypasses the filter media. In one embodiment the filter housing is installed in a countercurrent fashion to the supply and return line.

### RELATED APPLICATIONS

This application is a continuation-in-part application of application Ser. No. 09/931,230 filed Aug. 16, 2001, which will issue as U.S. Pat. No. 6,582,613 on Jun. 24, 2003.

### BACKGROUND

1. Field of Invention

This invention relates to a method and apparatus for filtering particulate matter from internal combustion engine coolant where a filter is connected between the heater core supply and return lines.

2. Description of the Prior Art

The use of engine coolant filters is known in the prior art.

U.S. Pat. No. 5,948,248 to Gene W. Brown, issued Sep. 7, 1999, describes an engine coolant filter which provides a delayed release of chemical additives to the coolant system.

U.S. Pat No. 5,382,355 issued Jan. 17, 1995, to Daniel A. Arlozynski discloses an Engine coolant filter having an automatic clogged-filter bypass valve and a visual indicator.

U.S. Pat. No. 3,776,384 to Offer discloses a replaceable element coolant filter including a pleated paper filter element for use in an existing water filter housing for internal combustion engine cooling systems by means of a grommet that serves to seat the element and seal it around the housing outlet.

U.S. Pat. No. 3,682,308 to Charles L. Moon, issued Aug. 8, 1972, describes an engine coolant filter comprising a filter base connected to a coolant conduit, a removable filter body, and check valves.

There is a need for a relatively simple and inexpensive coolant filter system which can be installed on new engines, or retrofitted to existing engines. It is desirable to provide a filter and a filtration method that will not adversely impact the operation of a vehicle or engine when the filter becomes plugged. It is desirable to provide a filter and filtration method that will filter coolant even when the vehicle heater is not turned on.

### SUMMARY OF THE INVENTION

The current invention is an engine coolant filter system and method for directing a portion of the normal coolant flow through heater hoses to a cartridge or media filter in order to remove particulate matter such as rust and scale.

An object of the present invention is to provide an improved engine coolant filter system for removing particulate matter such as scale and rust from an internal combustion engine cooling system.

In one embodiment, the filter is provided in a housing which may be directly inserted between the heater hoses so that additional fittings are not required. In this embodiment a portion of the flow is directed from the heater core supply line through the filter media to the heater core return line. The flow through the filter may be countercurrent such that flow from the heater supply line enters the housing at a first end, and exits the housing at an essentially opposite second end; and the flow from the heater return line enters the housing at the second end and exits the housing at the first end. The filter may be placed directly in the existing flow path by removing a section of the heater supply and return hoses, or may be located at a desired location such as above a wheel well or near exsiting supports.

Some embodiments of the invention include replaceable filter cartridges, such that a new cartridge may be installed in a filter housing. Other embodiments include a disposable housing, such that both the housing and the filter media are replaced.

Engine coolant flows into an inlet port on the filter housing, and a portion of that flow is forced through a filter medium, and exits the filter housing through an outlet port. Preferably, a portion of the overall flow of coolant through the engine is directed through the filter at all times that the engine is operational. By continuously filtering a relatively small portion of the overall coolant flow, the concentration of rust and scale is substantially reduced, thereby reducing corrosion and fouling, and improving thermal efficiency in the radiator.

The filter is preferably sized for various vehicles so that it may be replaced at the same time as the oil filter is normally changed, such as by the owner or by an oil changing service center.

### BRIEF DESCRIPTION OF THE DRAWINGS

These and other objects and advantages of the present invention are set forth below and further made clear by reference to the drawings, wherein:

FIG. 1 is a top view of an engine compartment with a heater core having a supply and a return line.

FIG. 6A is a top view of a block filter

FIG. 6B is an end view of a block filter

FIG. 6C is a side view of a block filter

FIG. 6D is a top cross-sectional view of a block filter

FIG. 6E is a top view of a block filter with a bolt-on housing

FIG. 7 is a perspective view of a cylindrical block filter

FIG. 8 is a detail of hose fittings

FIG. 9 is a side cross-sectional view of a block filter mounted on a wheel well mounting plate

FIG. 10 is a side cross-sectional view of a block filter mounted directly to a wheel well

FIG. 11 is a side cross-sectional view of a block filter strap-mounted on a wheel well

FIG. 12 is a perspective view of an embodiment

FIG. 13 is a perspective view of an alternate embodiment

### DESCRIPTION OF COUNTERCURRENT HEATER HOSE INSTALLATION EMBODIMENT

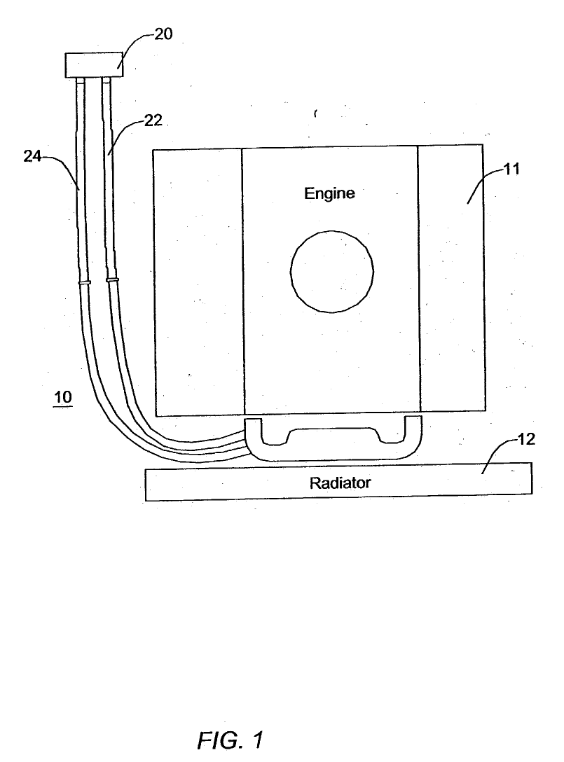

Referring now to FIG. 1, which is a top view of a heater hose embodiment of the an engine coolant filtration system 10, the system is comprised of an engine block 11, a radiator 12, a water pump 16 (not shown), a heater core 20, a heater core supply hose 22 for providing engine coolant from the water pump to the heater core, and a heater core return hose 24 for delivering engine coolant from the heater core to the water pump 16.

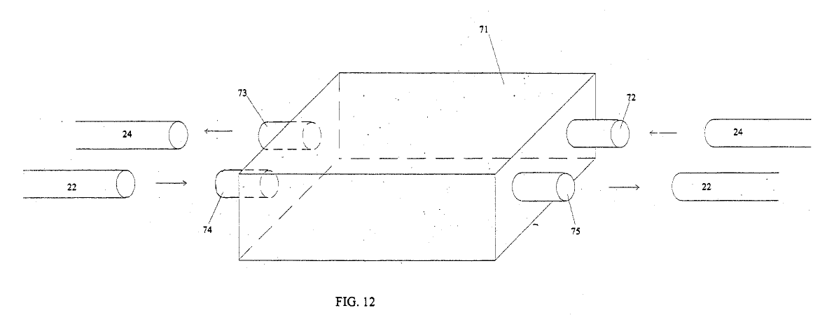

Referring now to FIG. 12, which is a perspective view of a heater hose embodiment of the engine coolant filtration system, a filter 71 is installed between the heater core supply hose 22 and the heater core return hose 24. In this example, the filter is positioned between the heater hoses and near the heater block, so that the heater block helps support the weight of the filter. In other embodiments, the filter is located near existing supports such as the wheel well, or firewall or existing bracket, and the heater hoses are run to the filter. In some cases, the heater hose may be replaced with longer sections in order to reach the filter.

The filter media 83 may be a replaceable paper filter in a generally elliptical housing 41 of length 6 inches, and width 3 inches, and height 1½ inches. Other filter types such as plastic, sand, and diatomaceous earth may be substituted for the paper filter. The housing includes an inlet port 42 and an exit port 43 so that a flow path is provided from the inlet port through the filter media and out the outlet port.

The filter is preferably sized so that a volume of about 3 to 5 times the total coolant in the cooling system is directed through the filter per hour of operation. For a coolant system of two gallon capacity, the preferred flow rate through the filter is about 6 to 10 gallons per hour, or about 0.1 to 0.16 gallons per minute. The housing is preferably about 6 inches long and 3 inches in diameter, so that it can trap about a pound of particulate matter before requiring replacement.

The filter may be manufactured by preparing the housing in two pieces, such as by injection molding, then inserting the filter media in one of the pieces, then attaching the second piece such as by gluing, threading, or welding.

The heater core supply hose 22 and heater core return hose 24 are typically ½ to ¾ inch diameter rubber hoses.

The filter is preferably sized for particular vehicle coolant capacities so that it may be replaced when the oil filter is normally changed, such as by the owner or by an oil changing service center.

### Description of Rectangular Housing Direct Connect Heater Hose Embodiment

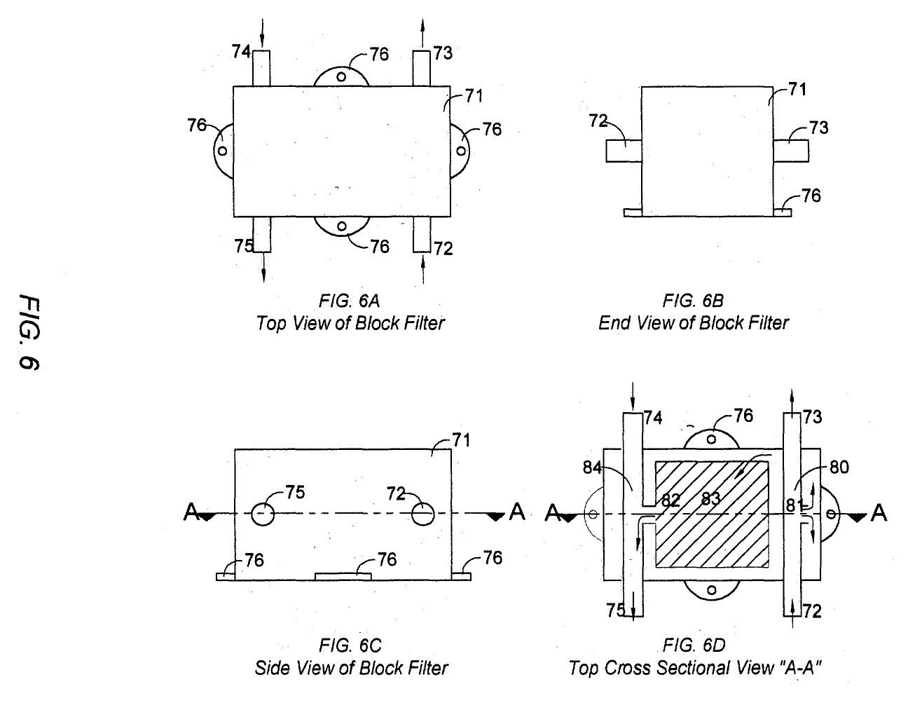

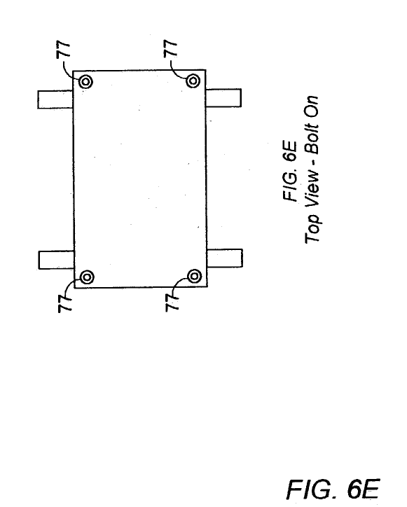

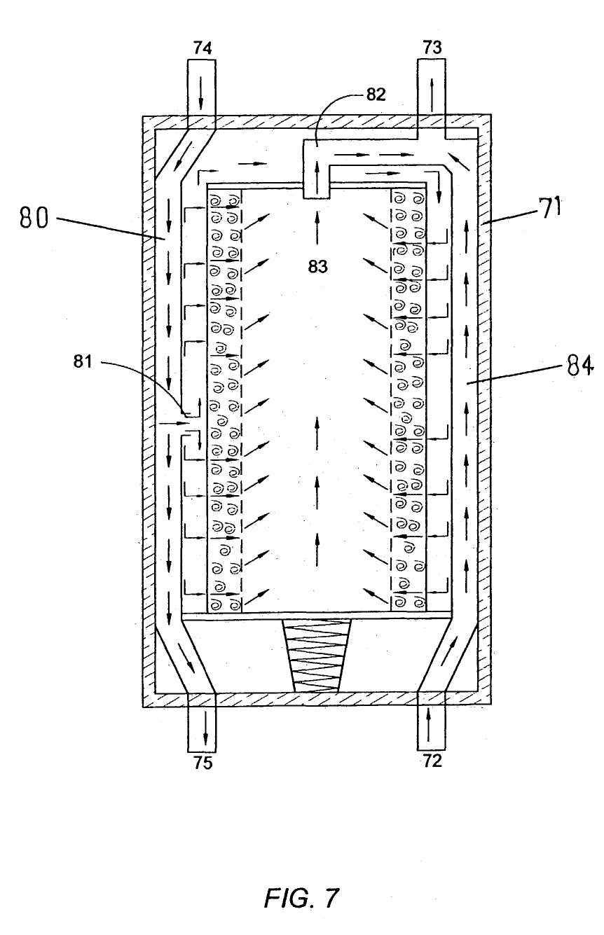

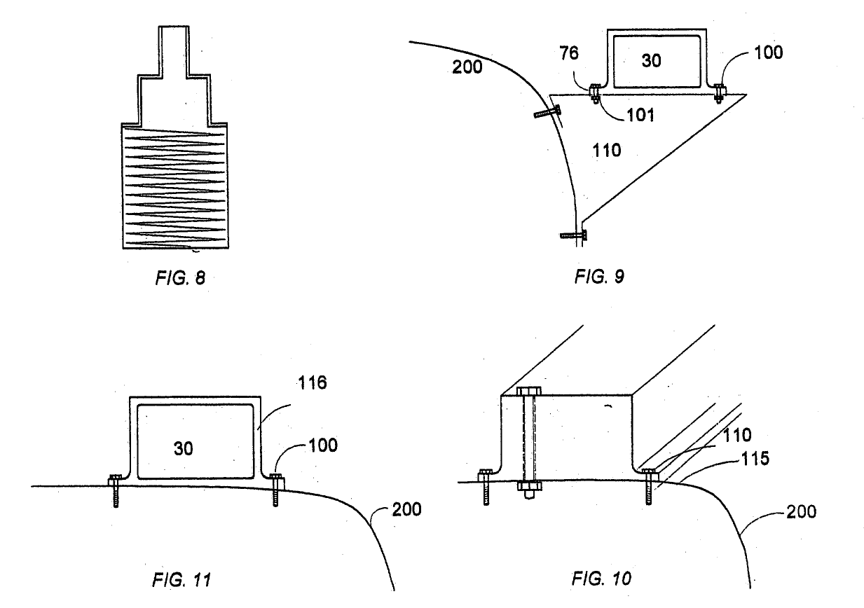

Referring now to FIG. 6A-6D, another embodiment of the invention features a housing 71 that includes connections 72 and 73 for the heater supply hose so that a section of the heater hose may be removed and the housing and may be inserted between the ends of the remaining hose. Similarly, the heater return line may be cut, and the return connections 74 and 75 may be inserted between the ends of the remaining supply hose. In this embodiment, most of the heater supply flow may continue through a passage 80 within the housing, but a portion of the flow is directed through an opening 81 in the passage where it can flow through a filter media 83. Similarly, most of the heater core return flow may continue through a passage 84 within the housing, and the portion of flow which has passed through the filter media may enter the return line through an opening 82 in the passage.

This filter may be manufactured by preparing the housing in two pieces, such as by injection molding, then inserting the filter media in one of the pieces, then attaching the second piece such as by gluing, threading, or welding. The filter media may be paper, sand, diatomaceous earth, plastic, or other media.

In one embodiment, this filter may be fastened within the engine compartment by using one or more flanged ears 76.

The hose connections 72, 73, 74, and 75 may be a single size. Alternately, the connections may be a universal fitting as shown in FIG. 8 so that the fittings may accommodate hoses of different diameters.

This filter is not limited to engine coolant, but may be used for other fluids.

### Description of Embodiment

Referring now to FIG. 7, in one embodiment, a cylindrical or elliptical housing 71 may be inserted between cut-out sections of heater supply and heater return hoses. This embodiment is similar to the rectangular housing described above, with heater supply and return flow going through the housing with a portion of the flow directed through a passage 81 in the supply line, through the filter media 83, and back through a passage in the return line 82.

Referring now to FIG. 7, in this embodiment, a cylindrical housing which is inserted between cut-out sections of heater supply hose 22 and the heater return hose 24. The heater supply hose 22 is connected to the filter at the supply inlet port 74, such as with a hose clamp. The supply flows through a supply channel 80 to a supply outlet port 75. The heater return hose 24 is connected at heater return inlet port 72. The return flow is through a return channel 84 to an outlet port 73. The pressure in the supply passage 80 is greater than in the return passage 84, so a portion of the supply flow is directed through a filter media inlet port 81 through a filter media 83 to a filter media outlet port 82 and then to the outlet port 73.

The amount of flow directed through the filter may be modified by increasing the pressure drop between the heater supply line and the heater return line. In general, the filter may be installed between the supply and return lines for a pressure drop device. In one embodiment, the pressure drop device is a heater valve in a heater core for an automotive vehicle.

In this embodiment, the filter will operate in a first state where the heater valve is open and a portion of the flow in the heater supply line goes through the filter be pass channel 80 and onto the heater, and another portion of the flow is directed through the filter media to the heater return line. The filter will also operate in a second state where the heater valve is closed and flow is from the heater supply hose through he filter media. In the case where the heater is operating, the flow in the filter housing may be countercurrent with flow in the supply passage 80 in a first direction and the flow in the return passage 84 in an essentially opposite direction. In the countercurrent example, if the filter media becomes clogged. Then there can still be flow to and from the heater through the supply and return passage.

Until the heater becomes clogged, it will continue to filter particulates when the heater is not operational. In this case, all flow through the heater supply inlet part 74 is directed though the filter media inlet part 81, through the filter media 83 and out the return outlet port 73. When the filter becomes clogged, there will be no flow through the filter media, and the heater supply line will remain pressurized as it would in operation without a filter when the heater valve is closed. Therefore, in either case of heater on or off, there is no adverse affect of the filter media becoming clogged.

In this embodiment, the filter housing may be a material such as metal or plastic. The housing may be sealed for one-time use so that it is typically replaced, such as at an oil change operation. Alternately the housing may be threaded in two or more pieces and screwed, or otherwise assembled so that the filter media may be accessed and replaced without removing the housing from the supply and return hoses.

### Description of Tire Well Installation Embodiment

Referring now to FIG. 9, the filter housing 30 may be installed on a mounting plate 110 which is bolted to a wheel well 200. The filter housing may be fastened to the mounting plate with bolts 100 and nuts 101 through the flange ears 76.

In an alternate installation as illustrated in FIG. 10, the filter housing 30 may be attached directly to a wheel well 200 with bolts or sheet metal screws through bolt-holes 115 in the housing.

In an alternate embodiment, the housing may be attached to a mounting bracket using the bolt-holes.

Referring now to FIG. 11, the housing may be attached to the wheel well with one or more mounting straps 116.

In another embodiment, as illustrated FIG. 6E, the housing may be bolted to a bracket or to the engine compartment with one or more bolts through bolt holes 77 in the housing.

### Description of Heater Hose Supported Embodiment

The filter assembly may be installed between the heater supply hose 22 and the heater return hose 24, and be supported by those hoses. When full of engine coolant, the filter assembly can be supported by one or both heater hoses if the filter assembly is connected to the heater hose near a heater hose clamp.

### Description of Embodiment—Oblong Housing

Referring now to FIG. 12 which is a perspective view of an embodiment of the filter housing, the hosing may be relatively thin in order to fit in the engine compartment of a vehicle. In this example, the filter is 6 inches long, with a width of 3 inches and a height of 2 inches. A single pass pleated paper filter media is used, having a nominal removal of particulates to about 5 microns. The filter has approximately 20 square inches of area and will hold about 4 ounces of filtered particulates.

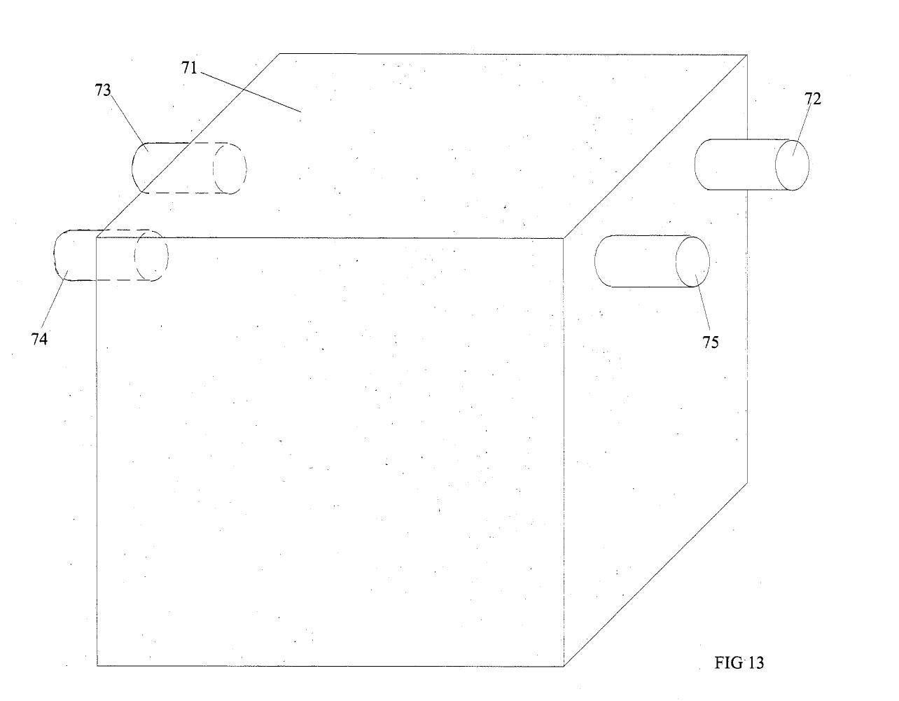

Referring now to FIG. 13, which is a perspective view of an embodiment of the filter housing, the housing may be of other shapes such as generally retangular.

What is claimed is:

24. A filter comprising
a filter media; and
a filter housing, the housing comprising
a first port,
a second port,
a first flow path located between the first port and the second port, the first flow path having at least one filter inlet opening within the filter housing, so that a portion of the flow through the first flow path may enter the filter housing,
a third port,
a fourth port, and
a second flow path located between the third port and the fourth port, the second flow path having at least one filter outlet opening within the filter housing, so that the flow through the first flow path may flow through the filter media, through the filter outlet opening, and into the second flow path, wherein the first flow path is countercurrent to the second flow path.

25. An engine coolant filter system comprising
an engine coolant;
a water pump;
an engine block;
a heater core;
a filter subassembly comprising
a filter media; and
a filter housing, the housing comprising
a first port,
a second port,
a first flow path located between the first port and the second port, the first flow path having at least one filter inlet opening within the filter housing, so that a portion of the flow through the first flow path may enter the filter housing,
a third port,
a fourth port, and
a second flow path located between the third port and the fourth port, the second flow path having at least one filter outlet opening within the filter housing, so that the flow through the first flow path may flow through the filter media, through the filter outlet opening, and into the second flow path;
a first heater core supply hose for providing engine coolant from the engine block to the first port;
a second heater core supply hose for providing engine coolant from the second port to the heater core;
a first heater core return hose for providing engine coolant from the heater core to the third port; and
a second heater core return hose for providing engine coolant from the fourth port to the water pump, wherein the first heater core supply hose and the first heater core return hose are arranged in a countercurrent configuration such that the first port and the fourth port are located on a first side of the filter housing, and the second port and the third port located on a second side of the filter housing, and the second side is essentially opposite of the first side.

26. The filtering system of claim 25 wherein
the filter housing is plastic.

27. The system of claim 25 wherein
the filter housing may be opened; and
the filter media may be replaced.

28. The system of claim 27 wherein
the filter housing is threaded, such that the filter housing may be opened by unscrewing the housing.

29. The system of claim 25 wherein
the filter media is paper.

30. The system of claim 25 wherein the supply line inlet port further comprises
a nipple, such that the first heater core supply hose may be clamped to the nipple.

31. The filtering system of claim 24 wherein
the filter housing is plastic.

32. The system of claim 24 wherein
the filter housing may be opened; and
the filter media may be replaced.

33. The system of claim 24 wherein
the filter housing is threaded, such that the filter housing may be opened by unscrewing the housing.

34. The system of claim 24 wherein
the filter media is paper.

35. A filter for a closed loop fluid system, the filter comprising
a filter media having a first surface and a second surface, such that a fluid may pass from the first surface, through the media, and to the second surface, thereby filtering particulates from the fluid, and
a housing comprising
a supply line inlet port,
a supply line exit port,
a supply passage between the supply line inlet port and the supply line exit port, at least one supply passage opening in the supply passage, such that a fluid may pass through the passage opening to the first surface of the media,
a return line inlet port,
a return line exit port,
a return passage between the return line inlet port and the return line exit port, and at least one return passage opening in the return passage, such that a fluid may pass from the second surface of the media through the return passage opening to the return line exit port,
such that a fluid may pass from the supply line inlet port, and a first portion of the fluid may pass through the supply passage, out the supply line exit port, through a pressure drop device, through the return line inlet port, through the return passage, and through the return line exit port, and a second portion of the fluid may pass through the supply passage opening, through the media, through the return passage opening, and through the return line exit port, such that the supply line and return line are arranged in a countercurrent configuration such that the supply line inlet port and the return line exit port are located on a first side of the filter housing, and the supply line exit port and the return line inlet port are located on a second side of the filter housing, and the second side is essentially opposite of the first side.

36. The filtering system of claim 35 wherein
the pressure drop device is a heater.

37. The system of claim 35 wherein
the filter housing is plastic.

38. The system of claim 35 wherein
the filter housing may be opened; and
the filter media may be replaced.

39. The system of claim 35 wherein
the filter media is paper.

40. A method of filtering a portion of the flow in a closed fluid loop, the method comprising
providing a fluid supply line with a first section and a second section;
providing a fluid return line with a first section and a second section, the fluid supply line having a higher pressure than the fluid return line;
positioning a filter housing between the first section and the second section of the fluid supply line and between the first section and the second section of the fluid return line, the filter housing containing a filter media;
providing a supply line bypass through the filter housing between the first section and the second section of the fluid supply line, so that a first portion of supply line fluid flows through the supply line bypass;
providing a return line bypass through the filter housing between the first section and the second section of the fluid return line, so that the first portion of supply line fluid flows through the return line bypass;
providing at least one opening in the supply line bypass to provide a second portion of the supply line flow to a filter media surface; and
providing at least one opening in the return line bypass to provide the second portion of filtered supply line flow from the filter media surface.

41. A method of filtering a fluid in a portion of a closed fluid loop, the portion of the closed fluid loop having a pressure drop device that is occasionally operative and a fluid supply line to the pressure drop device and a fluid return line from the pressure drop device, the method comprising
providing a filter having
a fluid supply line inlet port,
a fluid supply line outlet port,
a supply passage between the fluid supply line inlet port and the fluid supply line outlet port,
a fluid return line inlet port,
a fluid return line outlet port,
a return passage between the fluid return line inlet port and the fluid return line outlet port,
a filter media, and
a flow path from the supply passage through the filter media to the return passage;
installing the filter in a countercurrent manner between the fluid supply line and the fluid return line;
filtering a portion of the fluid flowing through the fluid supply line when the pressure drop device is operative by
flowing a first portion of the flow from the inlet supply port through the supply passage, through the pressure drop device, and through the return passage, and flowing a second portion of the flow from the inlet supply port through the flow path from the supply passage through the filter media to the return passage; and
filtering the fluid flowing through the fluid supply line when the pressure drop device is not operative by
flowing the flow from the inlet supply port through the flow path from the supply passage through the filter media to the return passage.
